(19) United States
(12) Patent Application Publication
(10) Pub. No.: US 2010/0132218 A1
(43) Pub. Date: Jun. 3, 2010

(54) DRYER WITH STATIONARY DRYING CYCLE

(76) Inventors: Soheil Etemad, Prospect, KY (US); Steven M. Recio, Louisville, KY (US); Erick Graven, Louisville, KY (US)

Correspondence Address: MERCHANT & GOULD GE CONSUMER & INDUSTRIAL, P.O. BOX 2903, MINNEAPOLIS, MN, 55402, US

(21) Appl. No.: 12/325,219

(22) Filed: Nov. 30, 2008

(51) Int. Cl. F26B 3/00; F26B 21/00; F26B 19/00; F26B 25/18

(52) U.S. Cl. 34/483; 34/528; 34/549; 34/239

(57) ABSTRACT

Systems and methods for operating a clothes dryer to provide a stationary drying cycle are disclosed. The systems may include a dryer having a drying compartment, a heating element configured to supply heat to the drying compartment and a controller for controlling operation of the dryer. The controller may be configured to cause the drum to remain stationary during the stationary drying cycle, and cause the heating element to supply heat to the drying compartment at a level appropriate for stationary drying. The methods may include receiving, at the controller, a stationary drying cycle setting and receiving, at the controller, an indication to start a drying cycle, wherein the drum remains stationary during the drying cycle.

### CROSS-REFERENCE TO RELATED APPLICATIONS

The present application is related to U.S. patent application having Ser. No. ______ titled “Dryer With Reverse Tumble Action” filed Nov. 30, 2008 having attorney docket number 60280.0009US01 and U.S. patent application having Ser. No. 11/853,271 titled “Centrifugal Switch Bypass for Reverse Tumble Dryers” filed Sep. 11, 2007, all of which are hereby incorporated by reference in their entirety.

### FIELD OF INVENTION

Embodiments of the present invention relate to appliances. More specifically, embodiments of the present invention relate to clothes dryers having a stationary drying cycle.

### BACKGROUND OF THE INVENTION

Currently when a consumer wishes to dry single items or special items, they experience problems when using a conventional drying cycle. For example, a consumer wishing to dry a pair of shoes using a conventional drying cycle causes excessive wear on both the dryer and the shoes. The shoes tumble within the dryer's drum and can damage the baffles within the drum. The baffles constantly strike the shoes causing damage. The alternative to using a conventional dryer is to simply let items set and dry in the open air. This method of natural drying is slow.

There exists a need for a dryer having a stationary drying cycle that can shorten drying times without causing unnecessary wear and tear on the dryer and the items being dried.

### BRIEF DESCRIPTION OF THE INVENTION

Consistent with embodiments of the present invention, systems for providing a stationary drying cycle in a tumble dry clothes dryer are disclosed. The systems include a dryer having a rotatable drum type drying compartment, a heating element configured to supply heat to the drying compartment, and a controller for controlling dryer operations. The controller may be configured to cause the drum to remain stationary during the drying cycle, and cause the heating element to supply heat to the drying compartment.

Still consistent with embodiments of the present invention, methods for operating a stationary drying cycle are disclosed. The dryer comprises a controller and a drum, the drum including a baffle. The methods may include receiving, at the controller, a drying cycle setting and an indication to start a drying cycle, wherein the drum remains stationary during the drying cycle.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts basic dryer components;

FIG. 2 depicts an dryer drum interior of a dryer having a first stationary position consistent with embodiments of the invention;

FIG. 3 depicts an dryer drum interior of a dryer having a second stationary position consistent with embodiments of the invention; and

FIG. 4 depicts a heating pan for gas dryers consistent with embodiments of the invention.

### GENERAL DESCRIPTION

Reference may be made throughout this specification to “one embodiment,” “an embodiment,” “embodiments,” “an aspect,” or “aspects” meaning that a particular described feature, structure, or characteristic may be included in at least one embodiment of the present invention. Thus, usage of such phrases may refer to more than just one embodiment or aspect. In addition, the described features, structures, or characteristics may be combined in any suitable manner in one or more embodiments or aspects. Furthermore, reference to a single item may mean a single item or a plurality of items, just as reference to a plurality of items may mean a single item. Moreover, use of the term “and” when incorporated into a list is intended to imply that all the elements of the list, a single item of the list, or any combination of items in the list has been contemplated.

Embodiments of the present invention utilize a baffle located within a drum in conjunction with the drum of a conventional dryer being stationary to improve drying effectiveness. During a drying cycle an item may be suspended from the baffle located within the drying compartment and heat applied without the drum rotating. In addition, at least two baffles located within the drum may be used to suspend items on a screen within the drying compartment.

### DETAILED DESCRIPTION

Various embodiments are described more fully below with reference to the accompanying drawings, which form a part hereof, and which show specific embodiments of the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Accordingly, the following detailed description is, therefore, not to be taken in a limiting sense.

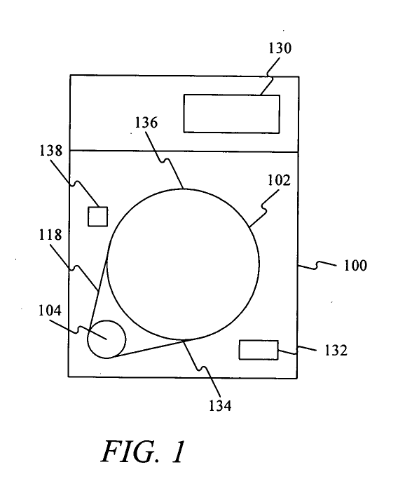

Referring now to the figures, FIG. 1 depicts a dryer 100. Dryer 100 includes a motor 104 used to rotate a drum 102. Motor 104 is operatively connected to drum 102 via a belt 118. Dryer 100 also includes a controller 130 for controlling operation of dryer 100 and a heating element 132 to supply heat to a drying compartment located within drum 102. Controller 130 includes a user interface including user actuable controls, which enable the user to input cycle selections including one or more stationary drying cycles, and to indicate load types, for example, delicates, or cottons, depending on the nature of the load to be dried. The input controls may be provided using mechanical knobs, tactile switches, capacitive touch switches, or some combination of such controls, all of which are well known in the art. The user interface may also include a visual display to indicate to the user the operating state of the dryer and other information, again using display devices of the type well known in the art.

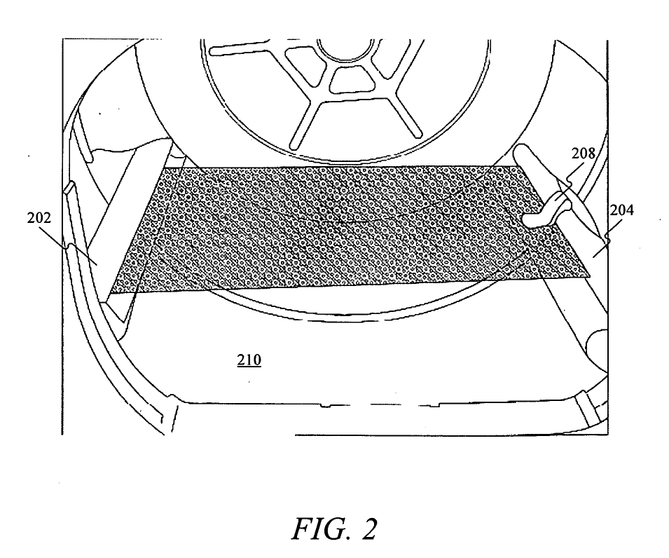

Referring now to FIG. 2, FIG. 2 depicts drum 102 in its stationary operational position. During stationary operation, drum 102 may be equipped with a screen baffle 202 and a hook baffle 204. Screen baffle 202 may contain a screen 206 that is comprised of a flexible heat resistant material that facilitates retraction and extension of screen 206 into and out of a storage cavity within screen baffle 202. Hook baffle 204 may contain a hook 208 to which screen 206 attaches during extension. As shown in FIG. 2, drum 102 is stationary such that screen baffle 202 and hook baffle 204 are located at toward the bottom of dryer 100 (see reference numeral 134 on FIG. 1) such that screen 206 forms a horizontal platform on which items such as shoes or other items may be placed for drying. In addition, drum 102 may be manually rotated in such a way that baffles 202 and 204 are in a desired position.

While FIG. 2 depicts screen 206 extending from screen baffle 202 and being secured to hook baffle 204, it is contemplated that screen 206 may be embedded within and extend from drum 102. For example, screen 206 may extend and retract from a drum sidewall 210. Hook 208 to which screen 206 attaches during extension may also be located on drum sidewall 210.

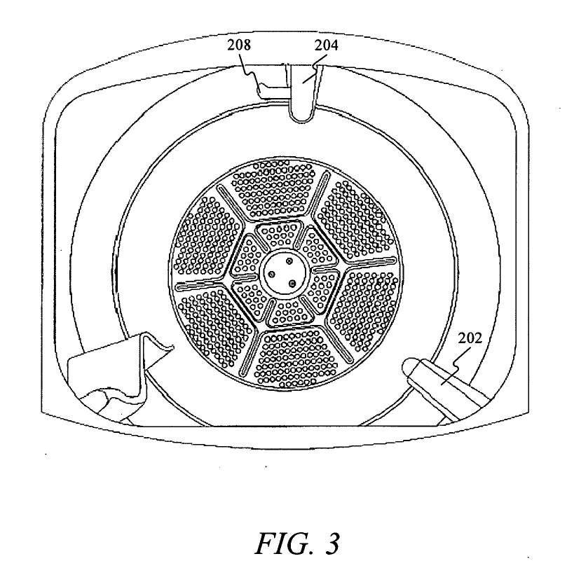

Referring now to FIG. 3, FIG. 3 depicts a second stationary position such that hook baffle 204 is located at the top of dryer 100. In the configuration depicted in FIG. 3, hook 208 may be used to suspend items within drum 102. For example, shoes may be suspended from hook 208 such that they may be dried without touching drum sidewall 210. As shown in FIG. 3, drum 102 is stationary such that hook baffle 204 is located toward the top of dryer 100 (see reference numeral 136 on FIG. 1) such that hook 208 may be used to suspend items (e.g. shoes) for drying.

A moisture sensor 138 may be operatively connected to controller 130. When moisture sensor 138 indicates a moisture level above a maximum moisture level, controller 130 may prohibit termination of the drying cycle.

In various aspects of the invention, depending on the type of items being dried, moisture sensor 138 may extend the drying cycle. However, moisture sensor 138 should not be able to extend the drying cycle for a prolonged period of time. For example, while drying tennis shoes, if moisture sensor 138 indicates a moisture level above the maximum moisture level, the drying cycle may be extended for 30 minutes or one hour, but no longer than 1.5 hours. If drying a delicate item such as silk and moisture sensor 138 indicates moisture levels above the maximum moisture level, the drying cycle may be extended for 15 minutes or 30 minutes, but no longer than 45 minutes.

Consistent with embodiments of the present invention, moisture sensor 138 may also terminate the drying cycle prematurely. If moisture sensor 138 indicates a moisture level below a minimum moisture level, controller 130 may terminate the drying cycle. For example, if drying delicate linens for a preset time of 45 minutes and moisture sensor 138 indicates a moisture level below the minimum moisture level after 30 minutes, the drying cycle may then be terminated to save energy and prevent unnecessarily exposing the linens to excessive heat.

Regardless of whether dryer 100 is a gas dryer or electric dryer, during stationary operations the heat applied may be increased above and decreased below an amount of heat applied during rotation in a conventional drying cycle. A conventional drying cycle is a drying cycle in which drum 102 rotates. For instance, during stationary operations heating element 132 may only supply ¼th the heat of a conventional drying cycle. For example, during a conventional drying cycle heating element 132 may supply 2,440 watts of power and during a stationary drying cycle, heating element 132 may supply 610 watts of power.

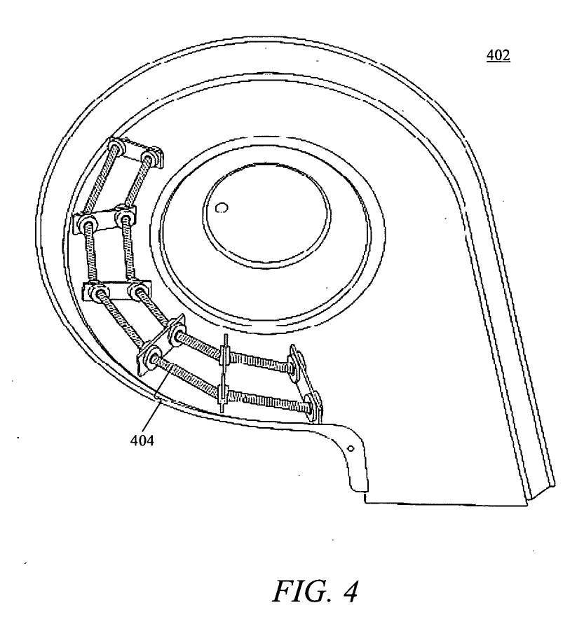

Referring now to FIG. 4, FIG. 4 depicts a heating pan 402 for gas dryers. Heating pan 402 includes an electric heating coil 404 that may be used to supply supplemental heat to gas dryers. There is a potential that at low gas flow rates, such as would be implemented for stationary drying cycles, the gas may not ignite or if it ignites, it may extinguish and create other unsafe scenarios. Therefore during stationary operations, if the dryer is a gas dryer, an electric heating element may be used to provide heat to dryer 100 instead of or in combination with a gas heating element. In addition, heating pan 402 and dryer 100 may include thermostats, flow sensors, gas sensors, etc. to monitor heating element temperatures and monitor dryer operations to detect dangerous scenarios such as a gas buildup, detect low gas flow conditions, incomplete combustion, excessive heat buildup within heating elements, etc.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A dryer having a blower fan and a motor for providing airflow, the dryer configured for operating a plurality of drying cycles, including a stationary drying cycle, the dryer comprising:
a drying compartment;
a motor operatively connected to the drying compartment and configured to cause the drying compartment to rotate;
a heating element operatively connected to the drying compartment and configured to supply heat to the drying compartment; and
a controller for controlling operation of the dryer including user operable input controls for selecting from the plurality of drying cycles, the controller operatively connected to the heating element and the motor, the controller configured to:
cause the drying compartment to remain stationary during the drying cycle in response to user selection of a stationary crying cycle, and
cause the heating element to adjust the heat supplied to the drying compartment in accordance with the user selected drying cycle.

2. The dryer of claim 1, further comprising a holder attached to a sidewall of the drying compartment and configured to suspend an item in the drying compartment.

3. The dryer of claim 1, further comprising a hook-baffle configured to expose a hook within the drying compartment, the hook configured to enable suspension of an item within the drying compartment.

4. The dryer of claim 3, wherein the drying compartment is a drum and the controller is further configured to cause the drum to rotate such that the hook is located at the top of the drying compartment in response to user selection of a stationary drying cycle.

5. The dryer of claim 1, further comprising a horizontal shelf positioned proximate the bottom of the drying compartment and configured to support an item within the drying compartment.

6. The dryer of claim 5 wherein the horizontal shelf comprises a screen, wherein the screen is configured through used of a hook-baffle configured to expose a hook within the drying compartment and a screen baffle configured to facilitate the extraction of the screen stored therein, wherein the screen extends from the screen baffle and is configured to engage the hook-baffle.

7. The dryer of claim 1, further comprising a moisture sensor located substantially within the drying compartment, wherein the controller is further configured to:
receive an input from the moisture sensor representative of a moisture level within the drying compartment; and
extend the drying cycle when the input indicates the moisture level within the drum is greater than a preset moisture level.

8. The dryer of claim 1, wherein the controller is further configured to actively modify the heat supply delivered to the drying compartment during a stationary drying cycle.

9. The dryer of claim 1, further comprising a moisture sensor located substantially within the drying compartment, wherein the controller is further configured to:
receive an input from the moisture sensor representative of a moisture level within the drying compartment; and
terminating the drying cycle when the moisture level is below a minimum moisture level.

10. A method for operating a stationary drying cycle within a dryer, the dryer comprising a controller, a heating element and a drying compartment, the method comprising:
receiving, at the controller, a stationary drying cycle setting;
receiving, at the controller, an indication to start a drying cycle, wherein the drum remains stationary during the drying cycle; and
causing the heating element to adjust the heat supplied to the drying compartment.

11. The method of claim 10, further comprising:
receiving, at the controller, a drying compartment position indication;
rotating the drying compartment to a desired position when the drying compartment position indication indicates the drying compartment is not in the desired position.

12. The method of claim 10, further comprising:
receiving, at the controller, a drying compartment position indication;
rotating the drying compartment to position a hook located within the drying compartment at the top of the drying compartment such that an item may be suspended within the drying compartment by the hook.

13. The method of claim 10, further comprising:
receiving, at the controller, a moisture indication indicating a moisture level within the drying compartment;
terminating the drying cycle when the moisture level is below a minimum moisture level.

14. The method of claim 10, further comprising:
receiving, at the controller, a moisture indication indicating a moisture level within the drying compartment;
extending the drying cycle when the moisture level is above a preset moisture level.

15. A dryer having a blower and a motor to provide airflow, the dryer configured for operating a plurality of drying cycles, including a stationary drying cycle, the dryer comprising:
a drying compartment;
a motor operatively connected to the drying compartment and configured to cause the drying compartment to rotate;
a heating element operatively connected to the drying compartment and configured to supply heat to the drying compartment; and
a controller for controlling operation of the dryer including user operable input controls for selecting from the plurality of drying cycles, the controller operatively connected to the motor, the controller configured to:
cause the drying compartment to remain stationary during the drying cycle in response to user selection of a stationary crying cycle, and
cause the heating element to supply heat to the drying compartment in accordance with the user selected drying cycle; and
a first baffle located within the drying compartment and configured to locate an item in the drying compartment.

16. The dryer of claim 15, further comprising:
a second baffle configured to expose a screen within the drying compartment,
wherein the screen extends from the second baffle and is configured to engage the first baffle,
wherein the controller is further configured to rotate the drying compartment in response to user selection of a stationary drying cycle, into a position such that the screen forms a horizontal shelf for supporting the item within the drying compartment.

17. The dryer of claim 15, wherein the first baffle is configured to expose a holder within the drying compartment, the holder configured to enable suspension of the item within the drying compartment.

18. The dryer of claim 15, further comprising a moisture sensor located substantially within the drying compartment, wherein the controller is further configured to:
receive an input from the moisture sensor representative of a moisture level within the drying compartment; and
extend the drying cycle when the input indicates the moisture level within the drum is greater than a maximum moisture level.

19. The dryer of claim 15, further comprising a moisture sensor located substantially within the drying compartment, wherein the controller is further configured to:
receive an input from the moisture sensor representative of a moisture level within the drying compartment; and
terminating the drying cycle when the moisture level is below a minimum moisture level.

20. The dryer of claim 15, wherein the controller is further configured to actively modify the heat supply delivered to the drying compartment during the drying cycle.
